(19) United States
(12) Patent Application Publication
(10) Pub. No.: US 2008/0101497 A1
(43) Pub. Date: May 1, 2008

(54) MIMO phase noise estimation and correction

(75) Inventors: Rohit V. Gaikwad, San Diego, CA (US); Rajendra T. Moorti, Mountain View, CA (US)

Correspondence Address: GARLICK HARRISON & MARKISON, P.O. BOX 160727, AUSTIN, TX, 78716-0727, US

(73) Assignee: Broadcom Corporation, a California Corporation, Irvine, CA (US)

(21) Appl. No.: 11/590,707

(22) Filed: Oct. 30, 2006

(51) Int. Cl. H04L 1/02

(52) U.S. Cl. 375/267

(57) ABSTRACT

A technique to estimate phase noise across a multiple-input-multiple-output (MIMO) communication channel, in which phase noise estimation is obtained by solving a matrix equation that has more unknowns than available equations. Once the phase noise estimate is determined, appropriate phase correction is applied to correct for phase noise induced errors in the received signal.

### BACKGROUND OF THE INVENTION

1. Technical Field of the Invention

The embodiments of the invention relate to wireless communications and more particularly to phase noise estimation and correction in a receiver of a multiple-input and multiple-output system.

2. Description of Related Art

Communication systems are known to support wireless and wire lined communications between wireless and/or wire lined communication devices. Such communication systems range from national and/or international cellular telephone systems, the Internet and to point-to-point in-home wireless networks. Each type of communication system is constructed, and hence operates, in accordance with one or more communication standards. For instance, wireless communication systems may operate in accordance with one or more standards including, but not limited to, IEEE 802.11, Bluetooth, advanced mobile phone services (AMPS), digital AMPS, global system for mobile communications (GSM), code division multiple access (CDMA), local multi-point distribution systems (LMDS), multi-channel-multi-point distribution systems (MMDS), and/or variations thereof.

Depending on the type of wireless communication system, a wireless communication device, such as a cellular telephone, two-way radio, personal digital assistant (PDA), personal computer (PC), laptop computer, home entertainment equipment, et cetera, communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel(s). For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via a public switch telephone network, via the Internet, and/or via some other wide area network.

For each wireless communication device to participate in wireless communications, it typically includes a built-in radio transceiver (i.e., receiver and transmitter) or is coupled to an associated radio transceiver (e.g., a station for in-home and/or in-building wireless communication networks, RF modem, etc.). The receiver may be coupled to an antenna and the receiver may include a low noise amplifier, one or more intermediate frequency stages, a filtering stage, and a data recovery stage. The low noise amplifier receives inbound RF signals via the antenna and amplifies them. The one or more intermediate frequency stages mix the amplified RF signals with one or more local oscillators to convert the amplified RF signal into baseband signals or intermediate frequency (IF) signals. The filtering stage filters the baseband signals or the IF signals to attenuate unwanted out of band signals to produce filtered signals. The data recovery stage recovers raw data from the filtered signals in accordance with the particular wireless communication standard.

The transmitter typically includes a data modulation stage, one or more intermediate frequency stages, and a power amplifier stage. The data modulation stage converts raw data into baseband signals in accordance with a particular wireless communication standard. The one or more intermediate frequency stages mix the baseband signals with one or more local oscillators to produce RF signals. The power amplifier amplifies the RF signals prior to transmission via an antenna.

In traditional wireless systems, the transmitter may include one antenna for transmitting the RF signals, which are received by a single antenna, or multiple antennas, of a receiver. When the receiver includes two or more antennas, the receiver generally selects one of them to receive the incoming RF signals. In this instance, the wireless communication between the transmitter and receiver is a single-output-single-input (SISO) communication, even if the receiver includes multiple antennas that are used as diversity antennas (i.e., selecting one of them to receive the incoming RF signals). For SISO wireless communications, a transceiver includes one transmitter and one receiver. Currently, most wireless local area networks (WLAN) that are IEEE 802.11, 802.11a, 802,11b, or 802.11g employ SISO wireless communications.

Other types of wireless communications include single-input-multiple-output (SIMO), multiple-input-single-output (MISO), and more recently, multiple-input-multiple-output (MIMO). In a SIMO wireless communication, a single transmitter processes data into radio frequency signals that are transmitted to a receiver. The receiver includes two or more antennas and two or more receiver paths. Each of the antennas receives the RF signals and provides them to a corresponding receiver path (e.g., LNA, down conversion module, filters, and ADCs). Each of the receiver paths processes the received RF signals to produce digital signals, which are combined and then processed to recapture the transmitted data.

For a multiple-input-single-output (MISO) wireless communication, the transmitter includes two or more transmission paths (e.g., digital to analog converter, filters, up-conversion module, and a power amplifier) that each converts a corresponding portion of baseband signals into RF signals, which are transmitted via corresponding antennas to a receiver. The receiver includes a single receiver path that receives the multiple RF signals from the transmitter.

For a multiple-input-multiple-output (MIMO) wireless communication, the transmitter and receiver each include multiple paths. In such a communication, the transmitter parallel processes data using a spatial and time encoding function to produce two or more streams of data. The transmitter includes multiple transmission paths to convert each stream of data into multiple RF signals. The receiver receives the multiple RF signals via multiple receiver paths that recapture the streams of data utilizing a spatial and time decoding function. The captured receive signals are jointly processed to recover the original data.

With the various types of wireless communications (e.g., SISO, MISO, SIMO, and MIMO) and standards (e.g., IEEE 802.11, IEEE 802.11a, IEEE 802.11b, IEEE 802.11g, IEEE 802.11n, extensions and modifications thereof), a large number of combination of types and standards is possible. However, when a wireless communication utilizes MIMO format for communicating between a receiver and a transmitter, complexities result due to the multiple transmission and receive paths for a given signal. Estimating channels at the receiver for a received signal generally requires taking into account the multiple signal paths from the transmitter.

In recovering the transmitted signal, channel estimation is performed to estimate the channel that the signal traverses and the signal is recovered through this estimation. A number of factors are known to impair or degrade the received signal when the receiver is performing channel estimation. One of these impairments is phase noise, in which noise introduced in the signal transmission path causes the signal components to be shifted in phase. Ordinary noise may introduce amplitude variations, but phase noise can introduce phase error, which affects the frequency response in the receiver. Generally, the phase error causes the received signal points to rotate within the signal constellation, so that signal points are not disposed at corrects locations within the constellation. Furthermore, additional complexities are introduced in a MIMO system since there are multiple paths for the transmitted signal, making phase error correction difficult to implement.

Accordingly, there is a need to provide a technique to estimate and correct for the phase noise in a MIMO receiver.

### SUMMARY OF THE INVENTION

The present invention is directed to apparatus and methods of operation that are further described in the following Brief Description of the Drawings, the Detailed Description of the Embodiments of the Invention, and the Claims. Other features and advantages of the present invention will become apparent from the following detailed description of the embodiments of the invention made with reference to the accompanying drawings.

### BRIEF DESCRIPTION OF THE SEVERAL VIEWS OF THE DRAWINGS

FIG. 1 is a block schematic diagram illustrating a wireless communication system in accordance with one embodiment of the present invention.

FIG. 2 is a block schematic block diagram illustrating a wireless communication apparatus in accordance with one embodiment of the present invention.

FIG. 3 is a diagram of a MIMO communication system having two antennas at a transmitter and two antennas at a receiver.

FIG. 4 is a diagram showing a dual mapping of a subcarrier index for transmitting from the two transmitter antennas for the system of FIG. 3.

FIG. 5 is a phase noise generation diagram for the 2×2 MIMO system of FIG. 3.

FIG. 6 is a diagram illustrating a technique to obtain common phase error (CPE) to quantify phase noise for each transmitted symbol.

FIG. 7 is a block circuit diagram of an apparatus showing one example implementation of a radio receiver to correct for phase noise.

### DETAILED DESCRIPTION OF THE EMBODIMENTS OF THE INVENTION

The embodiments of the present invention may be practiced in a variety of settings that implement a MIMO wireless communication device in which phase noise correction is desired.

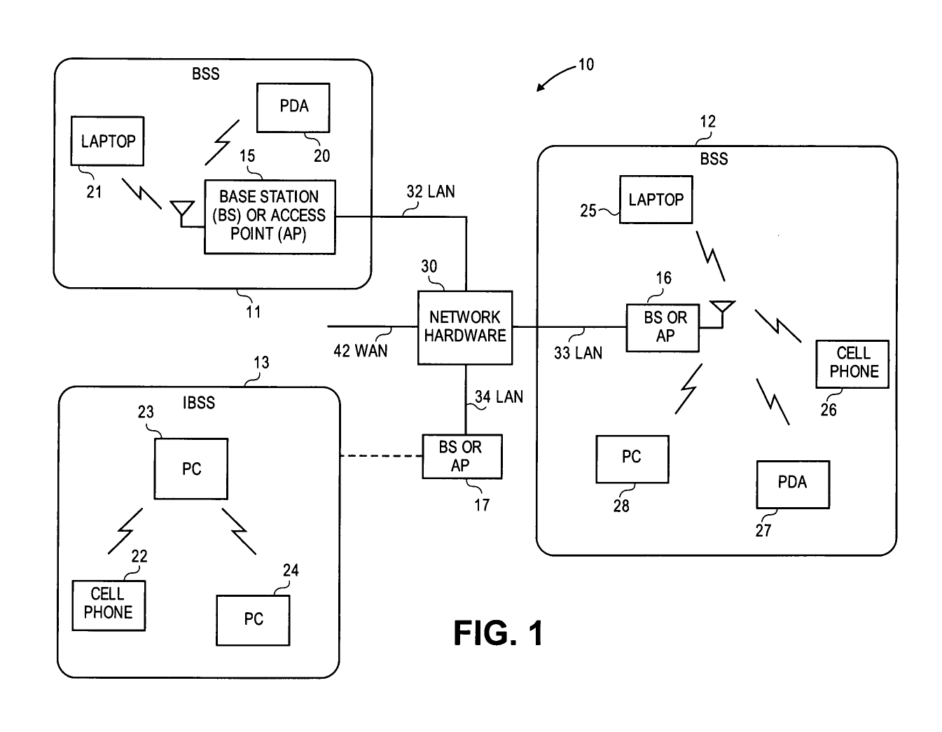

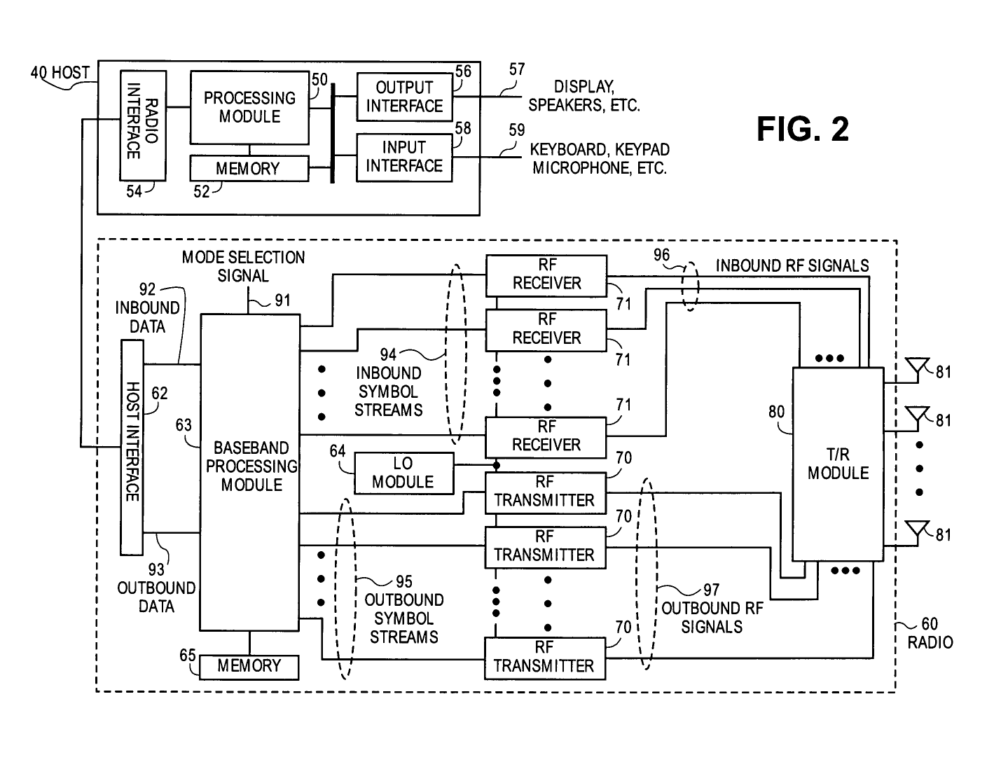

FIG. 1 is a schematic block diagram illustrating a communication system 10 that includes a plurality of base stations and/or access points (BS/AP) 15, 16, 17, a plurality of wireless communication devices 20-28 and a network hardware component 30. Network hardware component 30, which may be a router, switch, bridge, modem, system controller, et cetera, may provide a wide area network (WAN) coupling 31 for communication system 10. Furthermore, wireless communication devices 20-28 may be of a variety of devices, including laptop computers 21, 25; personal digital assistants (PDA) 20, 27; personal computers (PC) 23, 24, 28; and/or cellular telephones (cell phone) 22, 26. The details of the wireless communication devices shown is described in greater detail with reference to FIG. 2.

Wireless communication devices 22, 23, and 24 are shown located within an independent basic service set (IBSS) area 13 and these devices communicate directly (i.e., point to point). In this example configuration, these devices 22, 23, and 24 typically communicate only with each other. To communicate with other wireless communication devices within system 10 or to communicate outside of system 10, devices 22-24 may affiliate with a base station or access point, such as BS/AP 17, or one of the other BS/AP units 15, 16.

BS/AP 15, 16 are typically located within respective basic service set (BSS) areas 11, 12 and are directly or indirectly coupled to network hardware component 30 via local area network (LAN) couplings 32, 33. Such couplings provide BS/AP 15, 16 with connectivity to other devices within system 10 and provide connectivity to other networks via WAN connection 31. To communicate with the wireless communication devices within its respective BSS 11, 12, each of the BS/AP 15, 16 has an associated antenna or antenna array. For instance, BS/AP 15 wirelessly communicates with wireless communication devices 20, 21, while BS/AP 16 wirelessly communicates with wireless communication devices 25-28. Typically, the wireless communication devices register with a particular BS/AP 15, 16 to receive services within communication system 10. As illustrated, when BS/AP 17 is utilized with IBSS area 13, LAN coupling 17 may couple BS/AP 17 to network hardware component 30.

Typically, base stations are used for cellular telephone systems and like-type systems, while access points are used for in-home or in-building wireless networks (e.g., IEEE 802.11 and versions thereof, Bluetooth, and/or any other type of radio frequency based network protocol). Regardless of the particular type of communication system, each wireless communication device includes a built-in radio and/or is coupled to a radio.

FIG. 2 is a schematic block diagram illustrating a wireless communication device that includes a host 40 and an associated radio 60. Host 40 may be one of the devices 20-28 shown in FIG. 1. For cellular telephone hosts, radio 60 is typically a built-in component. For personal digital assistant hosts, laptop hosts, and/or personal computer hosts, radio 60 may be built-in or an externally coupled component.

As illustrated, host 40 includes a processing module 50, memory 52, radio interface 54, input interface 58 and output interface 56. Processing module 50 and memory 52 execute corresponding instructions that are typically done by the host device. For example, for a cellular telephone host device, processing module 50 may perform the corresponding communication functions in accordance with a particular cellular telephone standard.

Generally, radio interface 54 allows data to be received from and sent to radio 60. For data received from radio 60 (such as inbound data 92), radio interface 54 provides the data to processing module 50 for further processing and/or routing to output interface 56. Output interface 56 provides connectivity on line 57 to an output device, such as a display, monitor, speakers, et cetera, in order to output the received data. Radio interface 54 also provides data from processing module 50 to radio 60. Processing module 50 may receive outbound data on line 59 from an input device, such as a keyboard, keypad, microphone, et cetera, via input interface 58 or generate the data itself. For data received via input interface 58, processing module 50 may perform a corresponding host function on the data and/or route it to radio 60 via radio interface 54.

Radio 60 includes a host interface 62, a baseband processing module 63, memory 65, one or more radio frequency (RF) transmitter units 70, a transmit/receive (T/R) module 80, one or more antennas 81, one or more RF receivers 71 and a local oscillation module 64. Baseband processing module 63, in combination with operational instructions stored in memory 65, executes digital receiver functions and digital transmitter functions. The digital receiver functions include, but are not limited to, digital intermediate frequency to baseband conversion, demodulation, constellation demapping, decoding, de-interleaving, fast Fourier transform, cyclic prefix removal, space and time decoding, and/or descrambling. The digital transmitter functions include, but are not limited to, scrambling, encoding, interleaving, constellation mapping, modulation, inverse fast Fourier transform, cyclic prefix addition, space and time encoding, and digital baseband to IF conversion.

Baseband processing module 63 may be implemented using one or more processing devices. Such processing device(s) may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

Memory 65 may be a single memory device or a plurality of memory devices. Such a memory device may be a read-only memory, random access memory, volatile memory, non-volatile memory, static memory, dynamic memory, flash memory, and/or any device that stores digital information. Note that when processing module 63 implements one or more of its functions via a state machine, analog circuitry, digital circuitry, and/or logic circuitry, the memory storing the corresponding operational instructions may be embedded with the circuitry comprising the state machine, analog circuitry, digital circuitry, and/or logic circuitry.

In operation, radio 60 receives outbound data 93 from host 40 via host interface 62. Baseband processing module 63 receives outbound data 93 and based on a mode selection signal 91, produces one or more outbound symbol streams 95. Mode selection signal 91 typically indicates a particular mode of operation that is compliant with one or more specific modes of the various IEEE 802.11 standards. For example, in one embodiment mode selection signal 91 may indicate a frequency band of 2.4 GHz, a channel bandwidth of 20 or 22 MHz and a maximum bit rate of 54 megabits-per-second. In this general category, mode selection signal 91 may further indicate a particular rate ranging from 1 megabit-per-second to 54 megabits-per-second, or higher.

In addition, mode selection signal 91 may indicate a particular type of modulation, which includes, but is not limited to, Barker Code Modulation, BPSK, QPSK, CCK, 16 QAM and/or 64 QAM, as well as others. Mode selection signal 91 may also include a code rate, a number of coded bits per subcarrier (NBPSC), coded bits per OFDM symbol (NCBPS), and/or data bits per OFDM symbol (NDBPS). Mode selection signal 91 may also indicate a particular channelization for the corresponding mode that provides a channel number and corresponding center frequency. Mode select signal 91 may further indicate a power spectral density mask value and a number of antennas to be initially used for a MIMO communication.

Baseband processing module 63, based on mode selection signal 91, produces one or more outbound symbol streams 95 from outbound data 93. For example, if mode selection signal 91 indicates that a single transmit antenna is being utilized for the particular mode that has been selected, baseband processing module 63 produces a single outbound symbol stream 95. Alternatively, if mode selection signal 91 indicates 2, 3 or 4 antennas, baseband processing module 63 produces respective 2, 3 or 4 outbound symbol streams 95 from outbound data 93.

Depending on the number of outbound symbol streams 95 (e.g. 1 to n) produced by baseband processing module 63, a corresponding number of RF transmitters 70 are enabled to convert outbound symbol stream(s) 95 into outbound RF signals 97. Generally, each RF transmitter 70 includes a digital filter and up sampling module, a digital to analog conversion module, an analog filter module, a frequency up conversion module, a power amplifier, and a radio frequency bandpass filter. RF transmitters 70 provide outbound RF signals 97 to T/R module 80, which provides each outbound RF signal 97 to a corresponding antenna 81.

When radio 60 is in the receive mode, T/R module 80 receives one or more inbound RF signals 96 via antenna(s) 81 and provides signal(s) 96 to respective one or more RF receivers 71. RF receiver(s) 71 converts inbound RF signals 96 into a corresponding number of inbound symbol streams 94. The number of inbound symbol streams 94 corresponds to the particular mode in which the data was received. Baseband processing module 63 converts inbound symbol streams 94 into inbound data 92, which is provided to host 40 via host interface 62.

The wireless communication device of FIG. 2 may be implemented using one or more integrated circuits. For example, host 40 may be implemented on one integrated circuit, baseband processing module 63 and memory 65 may be implemented on a second integrated circuit, and the remaining components of radio 60 (less the antennas 81) may be implemented on a third integrated circuit. As an alternative embodiment, baseband processing module 63 and radio 60 may be implemented on a single integrated circuit. In another embodiment, processing module 50 of host 40 and baseband processing module 63 may be a common processing device implemented on a single integrated circuit. Furthermore, memory 52 and memory 65 may be implemented on the same memory device and/or on the same integrated circuit as the common processing modules of processing module 50 and baseband processing module 63. It is be noted that other embodiments may be implemented with the various units of FIG. 2.

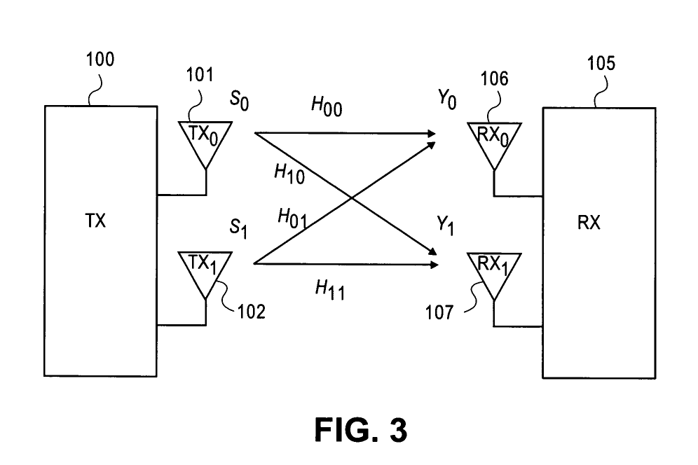

The various embodiments of the wireless communication device of FIG. 2 may be implemented in a transmitter and/or a receiver utilized for wireless communications. Typically, the communication is both ways so that the two units communicating typically will employ a transceiver in order to send and receive data. The multiple RF transmitters 70 and RF receivers 71 allow the device of FIG. 2 to be utilized in a multiple antenna transceiver system. FIG. 3 shows one particular example when communication is achieved using two antennas at the transmitter and two antennas at the receiver.

In FIG. 3 a transmitting (TX) unit 100 is shown having two antennas 101, 102, while a receiving (RX) unit 105 is shown having two antennas 106, 107. It is to be noted that both transmitting unit 100 and receiving unit 105 are generally both transceivers, but are shown as separate TX and RX units for exemplary purpose in FIG. 3. That is, TX unit 100 is transmitting data and RX unit 105 is receiving the transmitted data. The transmitted data symbols at antennas 101 (TX₀), 102 (TX₁) are noted as S₀ and S₁, respectively. The received data symbols at antennas 106 (RX₀), 107 (RX₁) are noted as Y₀ and Y₁, respectively. Since the example illustrates a two-transmit-antenna/two-receive-antenna MIMO system, the four resulting RF signal paths are noted as H₀₀, H₀₁, H₁₀ and H₁₁ (using the H_{RX-TX} notation) and the data path is referred to as channel H.

It is appreciated that the more advanced communication protocols may utilize multiplexed signals when transmitting data in order to increase the transmitted bandwidth. For example, orthogonal frequency division multiplexing (OFDM) utilize multiple tones in which each of the tones correspond to a sub-carrier (or sub-channel). The multiple signals are of equal energy and duration and the signal frequencies are equally separated, so that the signals are orthogonal to one another. In SISO systems, it is readily simple for the receiver to estimate the transmitted channel since there is only one transmit antenna and one receive antenna. Generally, the practice is to use a Fast Fourier Transform (FFT) so that each tone k is represented as:

Y(k)=H(k)S(k)+Z(k)

where S(k) denotes the known transmitted signal on sub-channel (or tone) k, H(k) denotes the frequency domain complex value of the impulse response of channel H on tone k, Y(k) denotes the signal at the receiver for each tone k and Z(k) denotes additive interference on each tone k. Neglecting for noise, a channel at the receiver may be identified by employing a one tap filter to equalize the received signal. A channel may be identified at the receiver by employing a channel estimation technique of estimating H from the received signal Y. For example, an estimation of H may be obtained from the above Y=HS equation (neglecting for noise) by employing a conjugate of S, in which H is defined as:

H=Y conjugate(S)=YS*

where * denotes a conjugate.

For example, in a typical communication scheme where receivers perform channel estimation to estimate the channel for a received signal, a training sequence(s) may be sent by the transmitter to train the receiver to estimate the channel. The training sequence is included in the preamble portion of a packet to educate the receiver as to the form of the transmitted signal. The data portion, referred to as a payload, follows the preamble portion. By utilizing one of a variety of techniques, such as an adaptive algorithm for maximum likelihood estimation, a receiver may converge toward an estimate of a given channel. For example, coefficients of a receiver equalizer may converge to a best estimate value for a channel during receiver training and then use the estimated values obtained from the training sequence to recover the transmitted data payload.

Thus, by utilizing a training signal in a preamble portion of a transmitted data stream from the transmitter, the receiver is able to configure itself to an estimated value of the channel for recovering the data. Applying the above equation, a known value may be transmitted with the training sequence of a preamble so that estimation of H may be determined. Once H estimation is calculated, H estimation is then utilized to operate on the payload to recover the data.

When multiple signals are transmitted from TX unit 100, H estimation is more complex, since there are now four potential H values (H₀₀-H₁₁) to decipher due to the multiple antenna paths. That is, in reference to FIG. 2, outbound data 93 may be split into one or more outbound symbol streams 95, which is then sent out as one or more outbound RF signals 97. In a two transmit antenna system, such as TX unit 100 of FIG. 3, outbound data 93 is split into two paths by baseband processing module 63 and transmitted from respective two antennas 81.

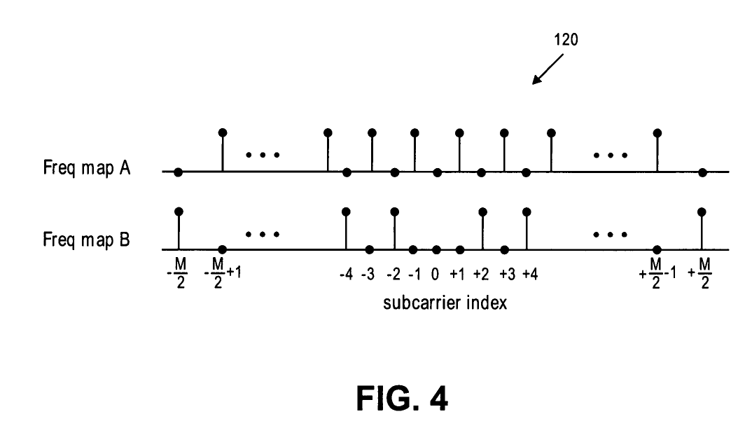

In a MIMO system, a variety of techniques may be implemented to transmit information from multiple transmitting antennas. For example, one technique of separating the outbound data into more than one transmitted data stream is illustrated in FIG. 4. FIG. 4 shows multiple tones that are transmitted by subcarriers of the transmitted signal. The shown multiple channel transmission is OFDM, but other multiplexed communication protocols may be used. The subcarrier index in FIG. 4 uses “M” to indicate a number of active subcarriers about a center carrier frequency fc (at index 0). The “+” numbers (+1, +2, +3 . . . ) indicate the upper band and the “−” numbers (−1, −2, −3 . . . ) indicate the lower band. In the particular embodiment shown, each subcarrier represents a tone for orthogonal signal transmission.

An orthogonal tone mapping diagram 120 is shown, in which the subcarriers are separated into two frequency maps, shown as frequency map A and frequency map B. As shown, frequency map A comprises the odd tones and frequency map B comprises the even tones. That is, when an outbound packet is processed into one or more sub-channels for transmission (such as by baseband processing module 63 of FIG. 2) based on a communication protocol selected, the energy content of the tones are concentrated in even or odd tones. In one embodiment, all of the tones are actually present, but odd tones are suppressed in one frequency map, while even tones are suppressed in the other frequency map. It is to be noted that various schemes may be readily used to transmit information from multiple transmitting antennas of a MIMO wireless communication system.

In particular, one example technique for even/odd tone separation is described in a co-pending patent application entitled “Channel estimation for orthogonal preambles in a MIMO system;” application Ser. No. 11/298,157; filed Dec. 9, 2005; and which application is incorporated herein by reference. The described technique transmits the energy content in even (or odd) tones during a first transmission block (block 0) from antenna TX₀ and during a subsequent time block (block 1), TX₀ transmits the other of the odd (or even) tones. Similarly, antenna TX₁ alternates between sending its odd and even tones for the two time blocks that the tones are sent, but the odd/even tones being sent are opposite to that of antenna TX₀. It is to be noted that all of the tones are present, but that some tones (even or odd, in this instance) have their energy content suppressed or zeroed-out. However, the invention need not be limited to this or any particular technique for sending orthogonal MIMO signals and embodiments of the invention may be readily made operable with variety of transmission schemes or protocols that utilize multiple transmitting and/or multiple receiving antennas.

With the transmission of signals across a channel H having multiple signal pathways (as noted in FIG. 3), the noise component that is encountered across the channel H may not be consistent. The variation in the noise across a MIMO system may then introduce phase components in the noise. When the signal is reconstructed at the receiver, the various noise components may introduce phase error, which affect how the signal is perceived at the receiver. Accordingly, as noted above, this phase noise introduces phase shifts in the received signal components so that signal reconstruction may be affected adversely.

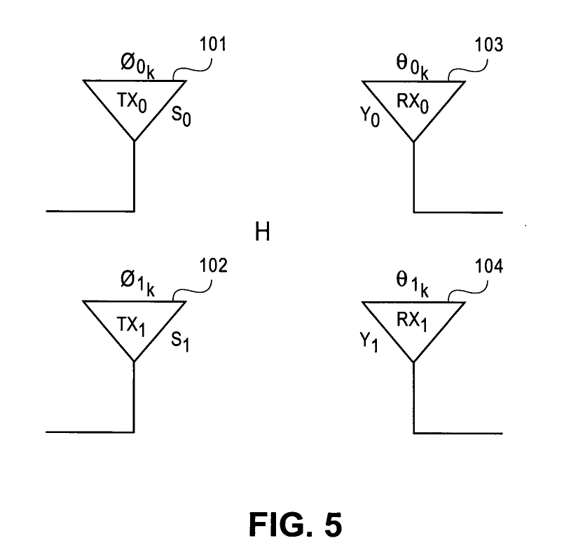

FIG. 5 illustrates a typical phase noise situation which is not encountered in SISO systems. Because there are four antennas present in a 2×2 MIMO system, four different noise components are illustrated, one each at the two transmitting sources and one each at the two receiving end. The phase noise components at the transmitting sources are noted as (φ₀ₖ and φ₁ₖ, where the first subscript (0 or 1) denotes antenna # (TX₀ and TX₁), respectively, and subscript k denotes a particular tone # of an OFDM signal. Likewise, phase noise components at the receive end are designated as θ₀ₖ and θ₁ₖ, which correspond to RX₀ and RX₁, respectively. It is to be noted that the phase noise component across the tones may vary and may not be a constant value across the tones.

Signal sent from the two transmitting antennas TX₀ and TX₁ follow the four pathways H₀₀, H₀₁, H₁₀ and H₁₁ (shown in FIG. 3) to receiving antennas RX₀ and RX₁. The receiver then combines the signals at the two receiving antennas RX₀ and RX₁ to recover the original signal.

When the four phase noise components of FIG. 5 are applied to the transmitted signals S₀ and S₁, the phase noise components associated with the received signals Y₀ and Y₁ at the receiving end may be represented as:
Y₀ₖ→θ₀ₖ+φ₀ₖ+φ₁ₖ is the combined phase noise for the received signal Y₀ₖ at RX₁,
Y₁ₖ→θ₁ₖ+φ₀ₖ+φ₁ₖ is the combined phase noise for the received signal Y₁ₖ at RX₁, and where k is the tone#.
   However, since channel H is present between the φ components and the θ components, the above relationship of phase noise to Y₀ₖ and Y₁ₖ is better represented as:

Y_{Rk}=θ_{Rk}H_{RTK}φ_{Tk}S_{Tk},

where R is the receiver antenna #, T is the transmitter antenna# and k is the tone #; and in matrix form as:

$$[ \begin{matrix}{Y}_{0 k} \\ {Y}_{1 k}\end{matrix} ] = [ \begin{matrix}{θ}_{0 k} & 0 \\ 0 & {θ}_{1 k}\end{matrix} ] [ \begin{matrix}{H}_{00 k} & {H}_{01 k} \\ {H}_{10 k} & {H}_{11 k}\end{matrix} ] [ \begin{matrix}{ϕ}_{0 k} & 0 \\ 0 & {ϕ}_{1 k}\end{matrix} ] [ \begin{matrix}{S}_{0 k} \\ {S}_{1 k}\end{matrix} ] .$$

### The above matrix equation denotes the separation of the transmit noise from the receive noise by channel H.

From the above matrix relationship, it is evident that two equations are available to represent the phase noise present in the received signals. However, there are four unknown variables in the two equations. Since four equations are necessary to solve for four unknowns, the above relationship is not possible to solve, unless some other technique is employed. Furthermore, if each of the tones are assumed to have different phase noise values, then the amount of the unknown variables is multiplied significantly. Accordingly, in order to simplify the calculation to solve for the phase noise, embodiments of the invention are described below to allow for the various phase noise components to be solved.

### Technique #1

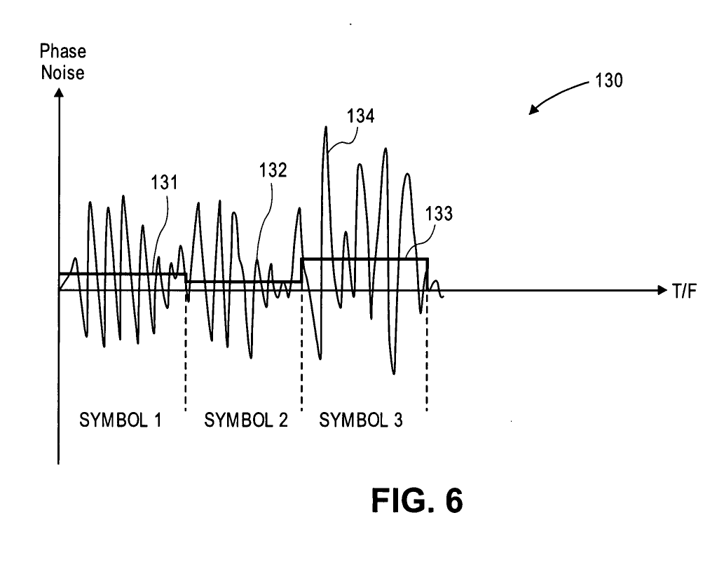

In order to simplify the above equation, a technique is described to obtain a common phase error value, which is an average of the noise component across the tones for a given symbol of the transmitted signal. As noted earlier in the description, the signal transmitted from the transmitting antennas is typically in symbol format, where each symbol includes a preamble, data payload or both. Accordingly, FIG. 6 shows a diagram 130 which illustrates a sequence of symbols 131, 132, 133 that are sent from the transmitter. Each of the symbols 131-133 has a phase noise component 134. Although the symbols 131-133 are shown in sequence of time (T), the phase noise component 134 is actually represented in frequency (F) along the X-axis. The phase noise typically varies across the tones of a given symbol. In order to simplify the phase noise calculation, a mean is estimated for the noise component of each symbol separately so that a value, referred to as Common Phase Error (CPE) is determined that makes the noise mean equal to zero for each symbol. Thus, in FIG. 6, a CPE value is determined for each of the symbols 131-133, by a zero mean value that differs from symbol to symbol. By determining a CPE value for each symbol, an average noise value is determined which may be applied across the various tones present in the signal corresponding to each of the symbols.

The matrix equation of

$$[ \begin{matrix}{Y}_{0 k} \\ {Y}_{1 k}\end{matrix} ] = [ \begin{matrix}{θ}_{0 k} & 0 \\ 0 & {θ}_{1 k}\end{matrix} ] [ \begin{matrix}{H}_{00 k} & {H}_{01 k} \\ {H}_{10 k} & {H}_{11 k}\end{matrix} ] [ \begin{matrix}{ϕ}_{0 k} & 0 \\ 0 & {ϕ}_{1 k}\end{matrix} ] [ \begin{matrix}{S}_{0 k} \\ {S}_{1 k}\end{matrix} ]$$

above may be rearranged by collapsing the φ and the θ components into H, so that the resulting relationship is represented as:

$$[ \begin{matrix}{Y}_{0 k} \\ {Y}_{1 k}\end{matrix} ] = [ \begin{matrix}{γ}_{00 k} {H}_{00 k} & {γ}_{01 k} {H}_{01 k} \\ {γ}_{10 k} {H}_{10 k} & {γ}_{11 k} {H}_{11 k}\end{matrix} ] [ \begin{matrix}{S}_{0 k} \\ {S}_{1 k}\end{matrix} ]$$

so that the earlier equation of Y_{Rk}=θ_{Rk}H_{RTK}φ_{Tk} S_{Tk} (where R is the receiver antenna #, T is the transmitter antenna# and k is the tone #) may be collapsed to:

Y₀ₖ=γ₀₀ₖH₀₀ₖS₀ₖ+γ₀₁ₖH₀₁ₖS₁ₖ

Y₁ₖ=γ₁₀ₖH₁₀ₖS₀ₖ+γ₁₁ₖ H₁₁ₖS₁ₖ

Then, if corresponding CPE values of γₓₓ are substituted across the tones, so that γ₀₀ₖ=γ₀₀, γ₀₁ₖ=γ₀₁, γ₁₀ₖ=γ₁₀ and γ₁₁ₖ=γ₁₁, then the equation may be further reduced to:

$$[ \begin{matrix}{Y}_{0 k} \\ {Y}_{1 k}\end{matrix} ] = [ \begin{matrix}{γ}_{00 k} {H}_{00 k} & {γ}_{01 k} {H}_{01 k} \\ {γ}_{10 k} {H}_{10 k} & {γ}_{11 k} {H}_{11 k}\end{matrix} ] [ \begin{matrix}{S}_{0 k} \\ {S}_{1 k}\end{matrix} ] ,$$

Y₀ₖ=γ₀₀H₀₀ₖS₀ₖ+γ₀₁H₀₁ₖS₁ₖ

Y₁ₖ=γ₁₀H₁₀ₖS₀ₖ+γ₁₁H₁₁ₖS₁ₖ

The matrix equations are simplified so that the four γₓₓ are left to be determined to arrive at an estimation of the phase noise for the received signal across all tones.

As described earlier above, two equations having four unknowns presented a problem in solving for the four components of phase noise. However, by utilizing a pilot tone or tones, of known values, additional equations may be provided to solve for the phase noise components.

In the transmission of OFDM signals, a pilot tone may be included that provides a known signal component, so that the receiver may use the pilot tone(s) to identify certain characteristics of the transmission or to align the receiver using the known pilot tone signal(s). Accordingly, a pilot tone p, which is a subset of tones k, may be used to transmit a known signal component that is detected in the receiver. If two pilot tones p₁ and p₂ are sent with known information that is to be decoded by the receiver, then two additional equations may be obtained with the use of pilot tones. With the transmission of two pilot tones from the two antennas, four equations are now available to solve for the four unknowns (2 antennas×2 pilots=4 equations). Applying the two pilot tones p₁ and P₂ to the Y₀ₖ and Y₁ₖ equations, results in the following:

Y₀₍ₚ₁₎=γ₀₀H₀₀₍ₚ₁₎S₀₍ₚ₁₎+γ₀₁H₀₁₍ₚ₁₎S₁₍ₚ₁₎

Y₁₍ₚ₁₎=γ₁₀H₁₀₍ₚ₁₎S₀₍ₚ₁₎+γ₁₁H₁₁₍ₚ₁₎S₁₍ₚ₁₎

Y₀₍ₚ₂₎=γ₀₀H₀₀₍ₚ₂₎S₀₍ₚ₂₎+γ₀₁H₀₁₍ₚ₂₎S₁₍ₚ₂₎

Y₁₍ₚ₂₎=γ₁₀H₁₀₍ₚ₂₎S₀₍ₚ₂₎+γ₁₁H₁₁₍ₚ₂₎S₁₍ₚ₂₎

where S₀₍ₚ₁₎, S₁₍ₚ₁₎, S₀₍ₚ₂₎ and S₁₍ₚ₂₎ are known quantities; Y₀₍ₚ₁₎, Y₁₍ₚ₁₎, Y₀₍ₚ₂₎ and Y₁₍ₚ₂₎ are predictable quantities; and Hₓₓ values are obtained through channel estimation techniques. Thus, four equations provide for a method of obtaining estimated values of the four phase noise components γₓₓ.

Accordingly, if P denotes the total number of pilot tones that may be used to transmit known information to the receiver, two pilot tones p₁ and p₂ (P=2) allows for the four noise components to be solved. Once γ₀₀-γ₁₁ are determined, θ₀₀-θ₁₁ and φ₀₀-φ₁₁ components may be obtained by uncollapsing the γ matrix.

Therefore, in a 2×2 MIMO system, the presence of two known pilot tones (P=2) allows for four equations to be solved for the four phase noise components. The technique may be expanded to solve for phase noise for any N×M MIMO system and is not limited just to a 2×2 system.

It is to be noted that with the described example 2×2 MIMO system, additional pilot tones may be used to develop more equations to solve for the phase noise components. For example, 8 pilot tones (P=8) may provide 16 equations (2 antennas×8 pilots=16 equations) to solve for the four unknowns. Additional pilot tones may help in converging to an estimate much faster or a better estimate may be obtained. However, too many pilot tones may result in an over-determined system where the benefit is cumulatively negligible. In some instances, a particular communication standard (or protocol) may limit the number of pilot tones that may be used. Accordingly, it may be desirable to use additional pilot tones, but a certain trade-off on the number to be used may depend on the particular system being implemented or standard being applied. In some applications, it may be possible to send test signals utilizing a substantial number of pilot tones or even all available tones.

Thus, one technique is to use one or more pilot tones with the sent signals to convey known information and this information is utilized in a phase noise estimation matrix to solve for the unknown phase noise components. In one embodiment described above for practicing the invention, the matrix equation is similar to that utilized for channel estimation in a MIMO receiver.

### Technique #2

In another technique for practicing the invention, instead of using pilot tones, some tones may be sent carrying data. By using a plurality of tones (pilot tones and data tones) in an OFDM signal, a decision directed phase estimation may be used. The technique is similar to Technique #1 above, but in this instance, an assumption is made as to the γ values, such as:

$$γ = [ \begin{matrix}1 & 1 \\ 1 & 1\end{matrix} ]$$

and an estimate is made of the transmitted signal

$$[ \begin{matrix}{S}_{0 k} \\ {S}_{1 k}\end{matrix} ] .$$

Subsequently, γ values are changed in order to converge the estimated S₀ₖ, S₁ₖ to the actual transmitted S₀ₖ, S₁ₖ. In some systems, a particular tone may provide a better or best fit to converge the equations and if not available for a pilot, then data may be sent on that particular tone(s). Thus, pilot tones, or in some instances pilot information sent in one or more data tones (or combination of pilot and data tones), allow for convergence of the equations having the four unknowns to solve the equations to determine the four phase noise components.

### Technique #3

In another technique for practicing the invention, the noise component(s) may be reduced from four to a lesser number. That is, when applying the matrix equations noted with Technique #1, the equations may be solved readily if there are only two unknowns, instead of four unknowns. This may be achieved by making pairs of the noise sources identical or very close to being the same. For example, by utilizing similar circuit characteristics, one pair or more of the phase noise components θ and φ may be reduced. Accordingly, when a transmitter is designed on an integrated circuit (IC) chip, design parameters for TX₀ and TX₁ are made to similar circuit characteristics. Since both transmitters TX₀ and TX₁ are generally manufactured on the same base substrate, the parameters may be kept substantially close, so that for all practical purpose the two have similar characteristics for noise. Thus, φ₀ₖ and φ₁ₖ may be designed to have the same characteristics so that φ₀ₖ=φ₁ₖ, reducing the phase noise unknowns to only three.

Likewise, receivers RX₀ and RX₁ may be designed to similar specifications, so that θ₀ₖ and θ₁ₖ are very close in value, so that θ₀ₖ=θ₁ₖ, requiring only three phase noise unknowns to be solved. Thus, if both receiver characteristics are made close and both transmitter characteristics are made close, then there are only two unknowns, allowing for simple solution of the phase noise matrix. Furthermore, in some instances it may be possible to make φ₀ₖ=φ₁ₖ=θ₀ₖ=θ₁ₖ, which reduces the number of unknowns to just one. With reduction of one or more phase noise unknowns, it is to be noted that the computational complexity to solve for θ and φ is reduced correspondingly, when applying the phase noise matrix to correct for the phase noise.

### Circuit Implementation

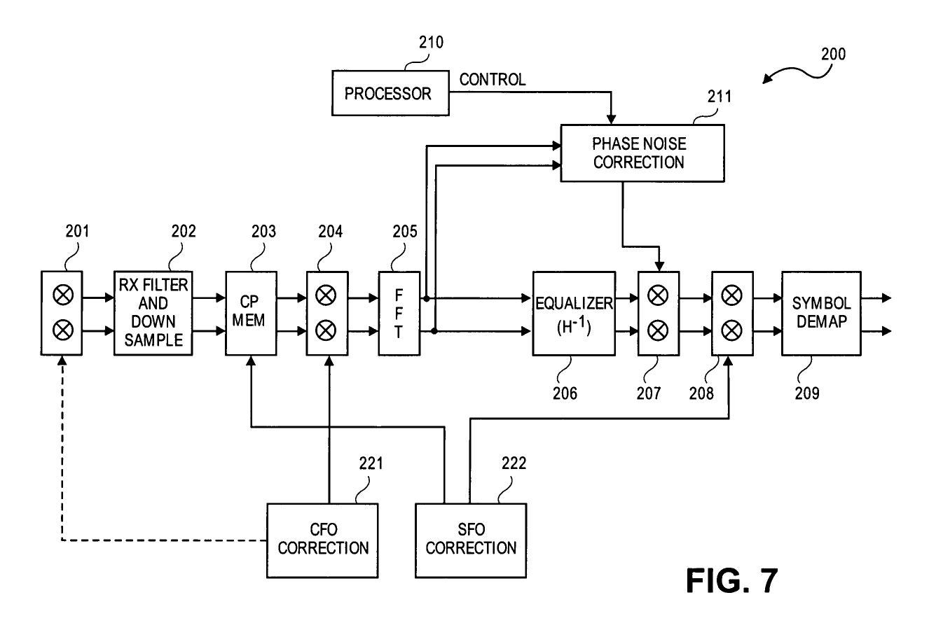

It is to be noted that the present invention may be practiced in a number of devices. For wireless communication, embodiments of the invention to determine phase noise in a receiver may be practiced in a number of radio receivers. For example, radio receivers 71 and baseband processing module 63 of FIG. 2 may be utilized to provide the down conversion of the RF signal and recovery of the data. The phase noise estimation and correction function may be obtained in the baseband processing module 63. In a 2×2 MIMO system, two receivers 71 would be utilized, one as RX₀ and the second as RX₁. Accordingly, FIG. 7 illustrates one example embodiment for implementing a circuit for practicing the invention.

FIG. 7 shows a block diagram of a receiver circuit 200, which is part of a MIMO receiver that uses multiple antennas to receive a MIMO signal. As noted above, one example technique for denoting noise sources in a 2×2 MIMO communication system relies on performing matrix operation on a received signal to estimate the effect of the channel on noise. The technique is similar to that used for performing channel estimation in a receiver to recover the transmitted signal. When phase noise estimation is performed along with channel estimation, the phase noise component may be corrected so that it does not interfere with the recovery of the transmitted signal. One circuit for performing the phase noise correction is illustrated in circuit 200 of FIG. 7. Circuit 200 may be implemented in the wireless communication apparatus of FIG. 2, which may be implemented in one or more devices shown in FIG. 1. Circuit 200 may be implemented in other devices as well.

Circuit 200 shows the dual signal paths of the 2×2 MIMO receiver, in which the received signals are coupled to a receive filter and down-sample module 202 via a phase correction module 201. Module 202 filters and down samples the received signals. The output of module 202 is coupled to a cyclic prefix removal module (CP REM) 203, which is used to correct for any cyclic slip (e.g. slippage of the current signal frame to previous or later signal frame). The output of CP REM module 203 is coupled to a carrier frequency offset (CFO) correction module 204, which output is then coupled to a Fast Fourier Transform (FFT) module 205 to transit from the time domain to the frequency domain for the incoming signal. The output of FFT is coupled to an equalizer 206, which uses a channel estimation technique to perform an inverse channel operation (H⁻¹) to the received signal. The output from equalizer 206 is coupled to a phase noise correction module 207, which is followed by a sampling frequency offset (SFO) correction module 208. The output of module 208 is coupled to a symbol demapping module 208.

It is to be noted that the CFO correction module 204 resides in the time domain and CFO correction is performed in the time domain, while noise and SFO correction modules reside in the frequency domain and these corrections are performed in the frequency domain. However, in other embodiments, the actual corrections may be performed in either of the domains for each of these corrections. Also, it is to be noted that one or more of the phase correction modules 201, 204, 207 and/or 208 may be phase locked loop (PLL) devices. Furthermore, the phase correction modules are shown separately for each function, but may be combined in some embodiments.

The modules prior to the FFT module 205 are generally utilized to filter, sample, correct and otherwise prepare the input signal for FFT conversion. CP REM 203 is shown, but is an optional component and may not be present in some embodiments. Similarly, phase correction module 201 is utilized to provide CFO preamble correction and may not be present in some instances where all of the CFO correction is made in phase correction module 204. FFT module 205 provides the time-frequency transformation so that the signal may be operated on in the frequency domain by equalizer module 206. Equalizer module 206 provides the H⁻¹ (channel inversion operation) to recover the intelligence transmitted through channel H and symbol demap module 209 provides the placement of the recovered symbols in the signal constellation to obtain the transmitted information.

The phase correction module 207 provides the phase correction and SFO correction module 208 provides for SFO phase correction. A phase noise correction module 211 under control of processor 210 receives the output of FFT module 205 and provides corresponding matrix operation to correct for the phase noise components described above. Phase noise correction module 211 may employ one of the techniques described above in solving for γₓₓ values and the phase noise components φ₀ₖ, φ₁ₖ, θ₀ₖ and θ₁ₖ. Once the component values are found, corresponding corrections are applied to phase correction module 207 to remove or reduce the phase noise.

In circuit 200, CFO correction module 221 and SFO correction module 222 are utilized to correct for CFO and SFO, respectively. CFO correction module 221 estimates for phase errors introduced in the received signal when the carrier frequency of the receiver is off from the actual transmitted carrier frequency (fc). One technique for estimating and correcting CFO is described in a co-pending patent application entitled “Apparatus and method for carrier frequency offset estimation and correction in a wireless communication system;” application Ser. No. 11/312,512; filed Dec. 21, 2005; and which application is incorporated herein by reference. When one CFO correction is applied, it is typically applied to phase correction module 204. However, in some instances, the CFO correction may be applied separately to a preamble of a packet and to a payload of the packet. For one embodiment, preamble CFO correction is applied to phase correction unit 201 (shown by the dotted line) and payload CFO correction is applied to phase correction module 204.

Likewise, SFO correction is utilized to correct for phase errors introduced by the actual sampling frequency being off from the desired sampling frequency value. SFO correction module 222 estimates for the SFO phase error and applies the correction to SFO phase correction module 208. One technique for estimating and correcting SFO is described in a co-pending patent application entitled “Apparatus and method for sampling frequency offset estimation and correction in a wireless communication system;” application Ser. No. 11/312,510; filed Dec. 21, 2005; which application is incorporated herein by reference. Also, module 222 also sends correction information to CP REM module 203 (if present) to adjust for any cyclic slip.

Thus, phase noise determination and correction in a MIMO system is described. It is to be noted that although a 2×2 MIMO system is described in detail, the practice of the invention for channel estimation is not limited to such 2×2 MIMO systems. For example, the afore-mentioned co-pending patent application entitled “Channel estimation for orthogonal preambles in a MIMO system;” application Ser. No. 11/298,157; filed Dec. 9, 2005, describe a 3×3 MIMO system. The embodiments of the present invention may be readily made operable with such 3×3 MIMO system or any N×M MIMO system with applicable adjustments to the weighting matrix (or matrices) used with such N×M system.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more of its corresponding functions and may further include inferred coupling to one or more other items.

Furthermore, the term “module” is used herein to describe a functional block and may represent hardware, software, firmware, etc., without limitation to its structure. A “module” may be a circuit, integrated circuit chip or chips, assembly or other component configurations. Accordingly, a “processing module” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions and such processing device may have accompanying memory. A “module” may also be software or software operating in conjunction with hardware.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. Similarly, flow diagram blocks and methods of practicing the embodiments of the invention may also have been arbitrarily defined herein to illustrate certain significant functionality. To the extent used, the flow diagram block boundaries and methods could have been defined otherwise and still perform the certain significant functionality. Such alternate definitions of functional building blocks, flow diagram blocks and methods are thus within the scope and spirit of the claimed embodiments of the invention. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. A method comprising:
estimating a phase error for a signal communicated across a multiple antenna communication channel, in which each transmitting antenna and each receiving antenna has a phase noise component for a channel matrix used to calculate phase noise present in the signal; and
correcting for the phase error by applying phase correction to the signal based on the estimated phase error.

2. The method of claim 1, wherein the estimating includes collapsing the phase noise component of each transmitting antenna and the phase noise component of each receiving antenna into a single channel matrix and deriving combined phase noise components in the channel matrix.

3. The method of claim 2, wherein the estimating includes obtaining a respective mean value for each of the combined phase noise components for a segmented portions of the signal and using the respective mean values as common phase error values for the segmented portion.

4. The method of claim 2, wherein the estimating includes obtaining a respective mean value for each of the combined phase noise components for a symbol of the signal in which the mean value has a noise mean of zero for the symbol.

5. The method of claim 3, wherein the estimating includes using information conveyed in one or more tones present in the signal to solve channel matrix equations that have more unknowns than equations when calculating the channel matrix to solve for the combined phase noise components.

6. The method of claim 3, wherein the estimating includes using information conveyed in pilot tones present in the signal to solve channel matrix equations that have more unknowns than equations when calculating the channel matrix to solve for the combined phase noise components.

7. The method of claim 2, wherein the phase noise components of the transmitting antennas or the phase noise components of the receiving antennas are substantially the same, so that a number of phase noise components as unknowns when solving channel matrix equations is reduced.

8. A method comprising:
receiving a symbol associated with a signal transmitted across a communication channel of a multiple-input-multiple-output (MIMO) communication system;
estimating a phase error for the signal, in which each transmitting antenna and each receiving antenna of the MIMO system has a phase noise component for a channel matrix used to calculate phase noise present in the signal; and
correcting for the phase error by applying phase correction to the signal based on the estimated phase error.

9. The method of claim 8, wherein the estimating includes collapsing the phase noise component of each transmitting antenna and the phase noise component of each receiving antenna into a single channel matrix and deriving combined phase noise components in the channel matrix.

10. The method of claim 9, wherein the estimating includes obtaining a respective mean value for each of the combined phase noise components for the symbol in which the mean value has a noise mean of zero for the symbol.

11. The method of claim 9, wherein the estimating includes using information conveyed in one or more tones present in the signal to solve channel matrix equations that have more unknowns than equations when calculating the channel matrix to solve for the combined phase noise components.

12. The method of claim 9, wherein the estimating includes using information conveyed in pilot tones present in the signal to solve channel matrix equations that have more unknowns than equations when calculating the channel matrix to solve for the combined phase noise components.

13. The method of claim 9, wherein the phase noise components of the transmitting antennas or the phase noise components of the receiving antennas are substantially the same, so that a number of phase noise components as unknowns when solving channel matrix equations is reduced.

14. An apparatus comprising:
a sampling module coupled to receive an incoming signal communicated across a multiple-input-multiple-output (MIMO) communication channel and to sample the incoming signal;
a Fast Fourier Transform (FFT) module coupled to transform the sampled signal from a time-domain signal to a frequency-domain signal;
a phase noise estimating module coupled to the FFT module to estimate a phase error for the transformed frequency-domain signal, in which each transmitting antenna and each receiving antenna has a phase noise component for a channel matrix used to calculate phase noise present in the transformed signal; and
phase correcting module coupled to receive a phase correction signal from the phase estimating module to correct for the phase error.

15. The apparatus of claim 14, wherein the phase noise estimating module collapses the phase noise component of each transmitting antenna and the phase noise component of each receiving antenna into a single channel matrix to derive combined phase noise components in the channel matrix.

16. The apparatus of claim 15, wherein the phase noise estimating module finds a respective mean value for each of the combined phase noise components for a symbol of the signal in which the mean value has a noise mean of zero for the symbol.

17. The apparatus of claim 15, wherein the phase noise estimating module uses information conveyed in pilot tones present in the signal to solve channel matrix equations that have more unknowns than equations when calculating the channel matrix to solve for the combined phase noise components.

18. The apparatus of claim 15, wherein the phase noise components of the transmitting antennas or the phase noise components of the receiving antennas are substantially the same, so that a number of phase noise components as unknowns when solving channel matrix equations is reduced.
